(19) United States
(12) Patent Application Publication
(10) Pub. No.: US 2014/0326821 A1
(43) Pub. Date: Nov. 6, 2014

(54) Geotextile Cutting and Collecting Apparatus and Method

(71) Applicant: Andrew L. Bishop, Ulster, PA (US)

(72) Inventor: Andrew L. Bishop, Ulster, PA (US)

(21) Appl. No.: 13/875,933

(22) Filed: May 2, 2013

(51) Int. Cl. B26D 1/18; B65H 18/10; B65H 18/02

(52) U.S. Cl. CPC B26D 1/185; B65H 18/028; B65H 18/10
USPC 242/533.8; 242/522; 83/491; 83/478

(57) ABSTRACT

A geotextile cutting apparatus having a lifting arm and cutting disk capable of cutting uniform width strips of geotextile material in the field. The uniform width strips of the geotextile material are then collected on a bobbin held and rotated by powered spindles on a variable width yoke of a collection apparatus, thus collecting the previously cut uniform width of geotextile material into compact rolls. The method of collecting geotextile material in the field having the steps including, cutting the material into uniform strips with a lifting arm having a cutting disk and then collecting those uniform strips on a rotating bobbin held and turned by rotating spindles on a variable width yoke.

### BACKGROUND OF THE INVENTION

1. Field of the Invention

The invention pertains to the field of methods and apparatus for recovery of landscape fabrics. More particularly, the invention pertains to removal of heavy gauge large area geotextile liners, as used in soil covers for industrial applications.

2. Description of Related Art

Geotextile liners comprise a wide range of sheet or mat materials used in various applications related to oil and gas exploration, construction, landscaping, and other industries. These geotextile liners may be porous, non-porous, natural or synthetic, and comprise one or more layers depending on their intended use. Most notably, the oil and gas exploration industry makes extensive use of geotextile liners in various aspects of drilling operations. Environmental concerns related to spillage of drilling fluids, hydro-fracking additives, and other potentially harmful contaminants dictate that drill pads are constructed with non-porous heavy gauge multi-ply geotextile liners as isolation layers comprising a heavy gauge plastic sheet ply between two separable felt plies that inhibit punctures from rocks or other objects above and below the geotextile liners. These isolation layers are formed from continuous lengths of geotextile material that are unrolled from bulk rolls in overlapping strips covering the entire area to be protected. The overlaps are then formed into water-tight seams by various methods such as heat sealing, welding the sheets together to create a single monolithic layer that may cover an area of 200,000 to 300,000 square feet. Gravel, sand, or soil distributed above the now isolated natural landscape provides a surface for vehicles and other machinery to move on, while chemicals potentially spilled in the area are prevented from leeching into ground water or contaminating native soils.

In other applications, geotextiles can be used to form a water-tight layer at the bottom of excavations to create artificial ponds for storage of fresh water used in hydro-fracking, or for storing contaminated water allowing natural evaporative mechanisms to return at least a part of the water to the environment without need for treatment. Similarly, ditches can be lined to channel contaminated fluids easily without fear of contaminating underlying soils or aquifers. In still further applications, geotextiles are used to create temporary road beds, protect embankments and protective berms against soil erosion, and other soil management purposes.

Many jurisdictions require that oil and gas drilling sites, whether productive or not, be returned to a “natural” state at the completion of drilling operations. Such requirements also apply to temporary ponds and other well related structures that would potentially pose a future environmental hazard, or are even just scenically unappealing.

In the past, it has been the practice in many cases to bury geotextile liners in-place. This has been particularly true of pond liners that can be pushed into the bottom of the pond excavation they line, and then buried with the soil previously removed from the same hole. However, this is not universally possible, and in some cases is environmentally undesirable as the geotextile liners themselves can become highly contaminated with drilling fluids and other harmful substances the liners are designed to block from seeping into underlying soils.

As a result, current best practice dictates complete removal of the liners from the drilling sites. The process of removal is complicated by the seamed connections that are created between sheets during the installation process. Whereas the geotextile liners can be applied directly to the ground in long sheets taken from a construction vehicle holding a bulk spool of material, the finished liner after seaming may cover an area of 200,000 to 300,000 square feet, making it unwieldy to handle in the removal process, and difficult to arrange in compact package for transport to landfills or recycling facilities.

Removal of the geotextile liners therefore first requires that the monolithic sheet be cut into smaller manageable sections. Currently, one method of doing this is to use a “pizza cutter” cutting wheel designed for scoring asphalt surfaces, attached to the bucket of a front end loader or other piece of heavy construction equipment. This method is not efficient however, as soft soils under the geotextile liners allow the target material to simply sink into the earth, rather than being cut by the wheel. As a result, cuts are completed manually using small knives such as gypsum cutters. In some cases this method is completely abandoned, and the geotextile liners are just torn into sections using a claw arm of a heavy construction vehicle.

Disposing of the geotextile liners is also difficult. In some instances the material is just packed into roll-off containers such as Dumpsters® and transported to landfills. In other cases, the material is placed into bailers, similar to the car crushers used in the scrap metal industry, and formed into blocks. In either case, the material so collected is not only unwieldy to handle and space consumptive in land fills, but also often unsuitable for recycling as the collection process also introduces rocks, soil, and other debris into the recovered material that may complicate or preclude the recycling of the high value polymers used to make the geotextile.

### SUMMARY OF THE INVENTION

The embodiments described herein provide apparatus and a method for rapidly cutting geotextile liners into manageable uniform strips, and then easily collecting those strips onto rolls that are free of excessive debris, inexpensively stored and transported, require less space in land fills, and are easily dealt with by recycling facilities. In a first operation, a cutting apparatus with a lifting arm attached to a skid steer, fork lift, or other self propelled carriage is slid under the geotextile liner. As the lifting arm of the cutting apparatus is moved forward, it lifts the geotextile liner off the ground and directs it to a powered circular cutting disk extending through the lifting arm. The geotextile liner is thus cut, allowing the two halves of the liner to slide off the sides of the lifting arm, past the cutting disk and back onto the ground.

In a second operation, one end of a strip of Geotextile liner previously cut is attached to a disposable bobbin secured at each end by powered rotating spindles attached to a yoke frame of a collection apparatus which, in turn is mounted to a fork lift, skid steer, or other self propelled carriage. In cases in which the geotextile is of sufficiently heavy gauge, the bobbin is unnecessary and the geotextile can be attached directly to the powered rotating spindles, as it is self supporting. The powered spindles then wind the geotextile strip into a compact roll. As the collection apparatus lifts the geotextile liner strips off the ground, debris on the Geotextile strips rolls or slides off the material being collected through normal gravitation. Optionally, the collection apparatus can be fitted with a scraper and/or brush unit through which the Geotextile passes prior to being wound on the roll.

### BRIEF DESCRIPTION OF THE DRAWING

FIG. 1A shows a side view of the geotextile cutting apparatus in combination with a generic skid-steer loader.

FIG. 1B shows a perspective view of the geotextile cutting apparatus.

FIG. 1C shows an engine and hydraulic pump coupled to the geotextile cutting apparatus.

FIG. 1D shows an electric generator coupled to the geotextile cutting apparatus.

FIG. 2A shows a side view of the geotextile collection apparatus in combination with a generic wheel loader fitted with a standard fork accessory.

FIG. 2B shows a perspective of the geotextile collection apparatus with a bobbin.

FIG. 2C shows an engine and hydraulic pump coupled to the geotextile collection apparatus.

FIG. 2D shows an electric generator coupled to the geotextile collection apparatus.

FIG. 2E shows a perspective of the geotextile collection apparatus directly rolling a sheet of geotextile.

FIG. 2F shows a pre-cleaning device coupled to a geotextile collection apparatus.

FIG. 3 shows a cutting apparatus in combination with a self-propelled walk-behind carriage.

FIG. 4 shows a collection apparatus in combination with self-propelled walk-behind fork lift.

FIG. 5 shows a flowchart of a first method for cutting and collecting geotextiles.

FIG. 6 shows a flowchart of a second method for cutting and collecting geotextiles

### DETAILED DESCRIPTION OF THE INVENTION

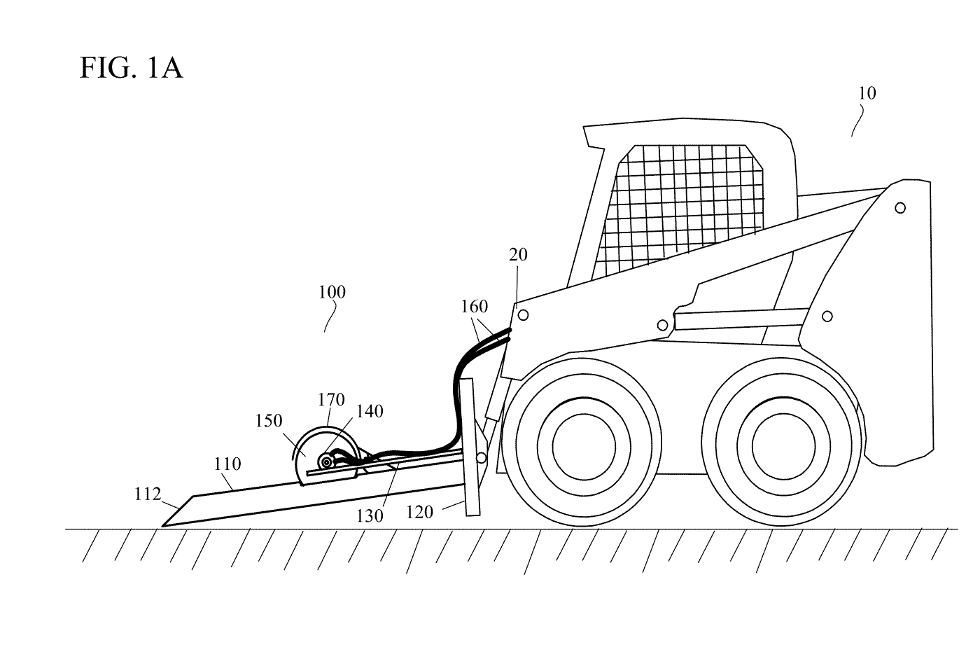

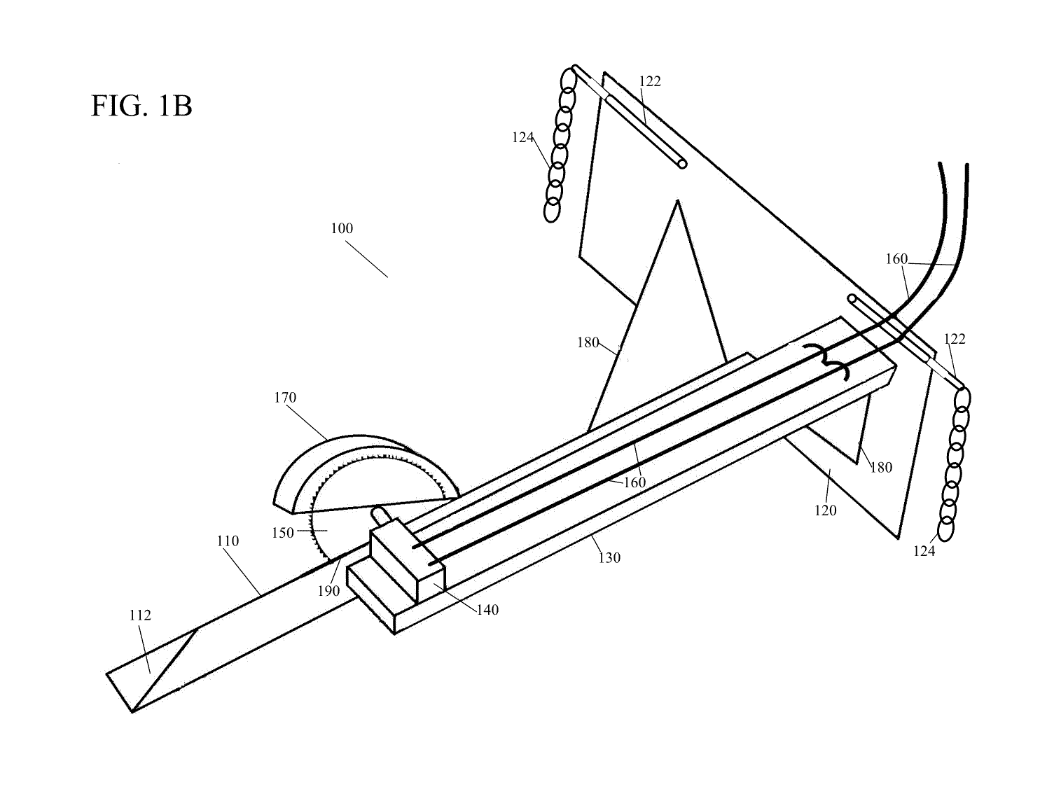

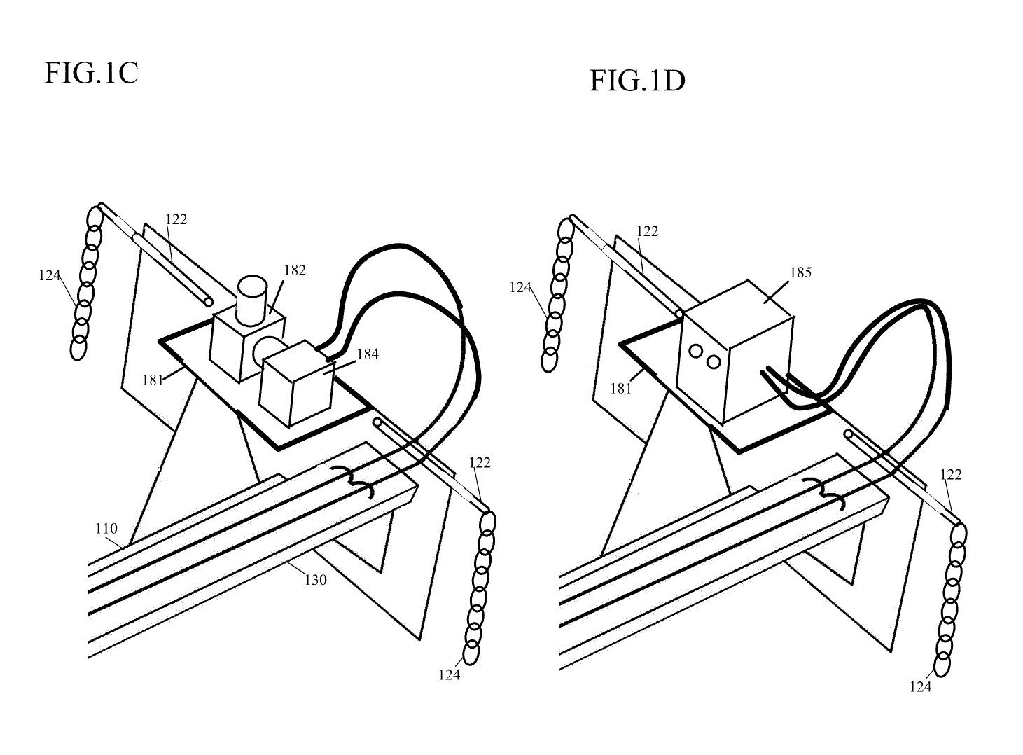

With reference now to the drawings, FIG. 1A illustrates the cutting apparatus 100 being used in conjunction with a representative self propelled carriage, in this case a generic skid steer loader 10. FIG. 1B shows a perspective view of the cutting apparatus 100 in greater detail. In a preferred embodiment of the cutting apparatus 100, a mounting plate 120, in this case a commercially available skid steer adapter plate, is used for mounting the cutting apparatus 100 components, and attachment of the cutting apparatus 100 to a self propelled carriage. A skid steer loader 10 is shown only as a preferred embodiment in this case, as such industry standard mounting plates 120 for custom skid steer loader 10 applications are readily available, and skid steer loaders 10 are commonly available in most construction and landscaping operations. In other embodiments an adapter plate 120 is fabricated to communicate with virtually any piece of light or heavy construction equipment, including but not limited to, fork lifts, bucket loaders, tracked vehicles, or other equipment having sufficient horsepower to carry the cutting apparatus 100 and the load of the geotextile on the lifting arm 110 when in operation. The adapter plate can also be adapted to work with a standard agricultural tractor three-point hitch and power takeoff.

The lifting arm 110 in this preferred embodiment is formed from a length of angle iron that has its one end welded to the mounting plate 120, with the angle pointing upward to form an apex. In this embodiment, a 6″×6″×½″ angle iron of roughly 5 foot length is used to form the lifting arm. However, these dimensions may vary widely depending on the target materials the cutting apparatus 100 is designed to separate. The opposite end of the lifting arm 110 is formed with a bevel 112 that allows the lifting arm 110 to easily wedge between the material to be cut and underlying surfaces, for the purpose of lifting the material to be cut off the underlying surface and guiding it along the lifting arm 110 to the cutting disk 150.

In this preferred embodiment, the lifting arm 110 is fixedly welded to the mounting plate 120 and reinforced with a sheet metal gusset 180 for lateral support. The back side of the mounting plate 120 is formed with an adaptor to fit upon the hydraulic arms 20 of the skid steer 10, to allow for both height adjustment and angulations of the mounting plate 120 and the attached lifting arm 110 in operation. In other embodiments where the self propelled carriage does not have such hydraulic arms 20, the attachment of the lifting arm 110 to the mounting plate 120 is made with a pivot that can be locked in position holding the lifting arm at an optimal angle relative to the horizontal, and/or sprung to allow for a range of vertical movement of the lifting arm 110 as it traverses potentially uneven terrain, with articulated linkages providing lateral support relative to the mounting plate 120.

One end of a service boom 130 is also welded to the mounting plate 120 parallel to, and slightly above, the top of the lifting arm 110. At the opposite end of the service boom 130, a motor 140 is mounted to drive a cutting disk 150 that penetrates through a cutting disk slot 190 in the lifting arm 100. In one preferred embodiment, the motor 140 is a hydraulic motor 140. This selection is made for its high torque characteristics and because most heavy and light construction vehicles have hydraulic systems that provide industry standard quick release connectors that accommodate hydraulic accessories. Hydraulic hoses 160 lead from the motor 140 for this purpose and connect to appropriate fittings on the skid steer 10 or other self propelled carriage that is employed.

In other embodiments, shown in FIG. 1C and FIG. 1D, a gasoline engine 182 or electric motor is mounted on a platform 181 on the mounting plate 120 in combination with a hydraulic pump 184 to provide motive power for the motor 140. In still further embodiments, the motor 140 is an electric motor and is provided with power through a gas powered generator 185 mounted on the mounting plate 120.

A cutting disk 150 guard 170 is employed to prevent injury from personnel coming in contact with the cutting disk 150, or from debris propelled by the cutting disk 150.

While the motor 140, cutting disk 150, and service boom 130 are shown such that the cutting disk 150 penetrates the lifting arm 110 cutting disk slot 190 from above, it is understood that this is only one preferred embodiment, and the cutting disc 150 can easily be arranged with its rotational axis underneath the lifting arm 110, allowing the disc 150 to penetrate the lifting arm 110 cutting disk slot 190 from below. The angle of the lifting arm 110 relative to the ground provides sufficient space for this purpose. In this case the cutting disk guard 170 is modified with flanges extending laterally away from the cutting disk 150 on each side, and forward of the cutting disk 150, to prevent the geotextile being cut from riding up and over the cutting disk. In this arrangement, the service boom 130 and motor 140 might also be mounted below the lifting arm 110.

In one preferred embodiment, the cutting disk 150 is an 18″ diameter concrete blade, chosen for its ability to cut through not only the geotextile target material, but also any rocks or other debris that may be carried into the blade as it traverses a cutting pathway. The choice of blade is, however, flexible and in other embodiments is chosen to include a conventional toothed blade, a chain toothed blade, sharpened disk, or other blade configuration appropriate to the target material to be cut.

Uniform width and straightness of cut can be important later in the rolling process. Outriggers 122 are provided for this purpose. In use, the outriggers 122 are adjusted such that guides 124 affixed to their outer end indicate a desired distance from the cutting disk 150 to a reference line used for guiding the cutting process. In one preferred embodiment the guide 124 is a chain that hangs close to the ground and can be easily sighted relative to the reference line of travel being used. In other embodiments, this guide 124 is a cable, laser light, adjustable rod, or other reference device.

Typically the operator has one straight edge of the geotextile liner to use as a reference, or uses a seam in the geotextile liner as a reference. Hence, the operator ensures that on each pass with the cutting apparatus, depending on the location of the reference edge relative to the direction of travel, the respective guide 124 follows the chosen reference. In this manner consistent width strips of geotextile are cut in straight uniform widths from the previously assembled geotextile liner.

A collection apparatus is employed to collect the strips of material previously cut into compact rolls that are easily stacked, space efficient, and accommodating to recyclers. Generally such a collection apparatus winds the strips on a bobbin, however in the case of heavy gauge geotextiles, a bobbin is not required as the geotextile is self supporting. The collection apparatus also provides spindles for holding the bobbin and causing it to rotate, creating a roll of geotextile, or for direct attachment of the geotextile if it is of sufficiently heavy gauge to be self supporting when it is rolled around the rotating spindles. The collection apparatus also has a frame or yoke that holds the bobbin or geotextile in operation provides for mounting on a self propelled carriage, provides a motive power source for the spindles, and have at least one side moveable or removable so completed rolls can be deposited for transport.

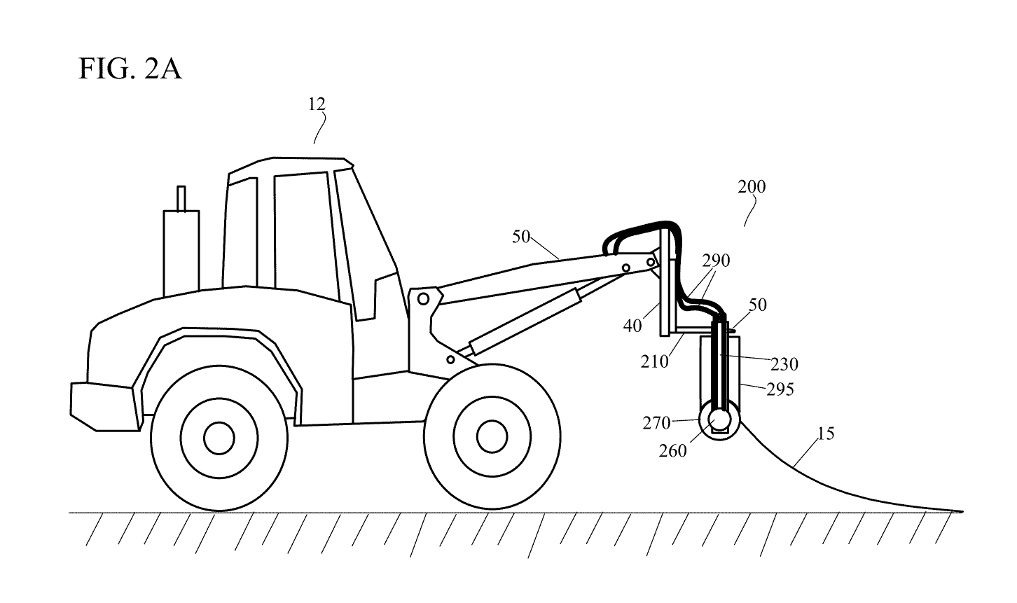

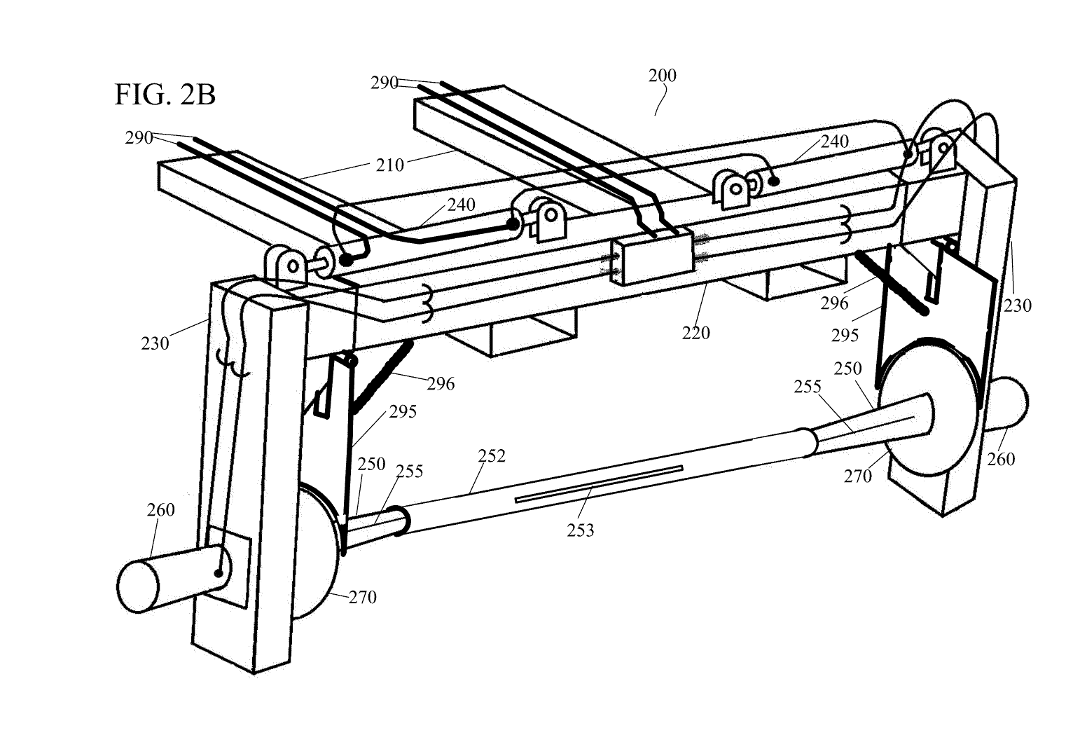

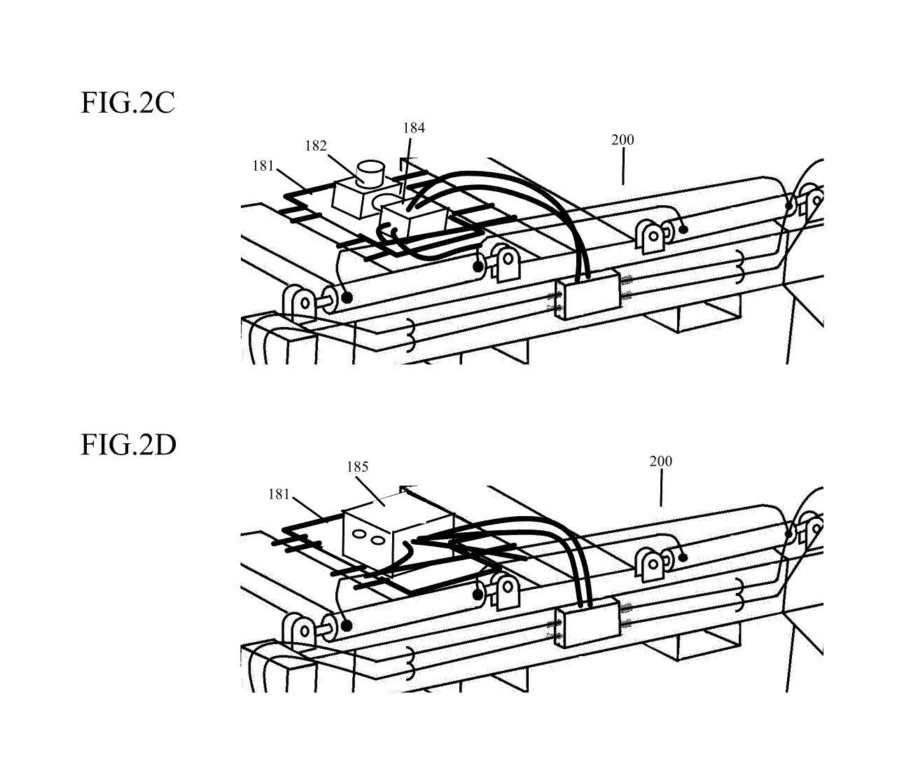

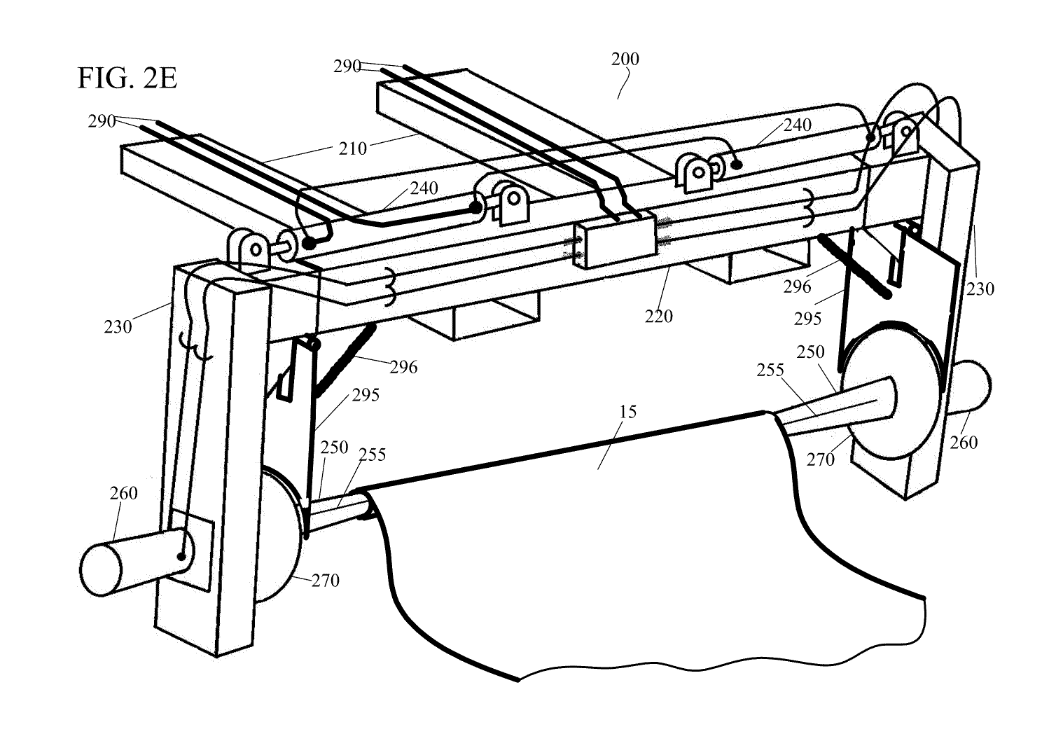

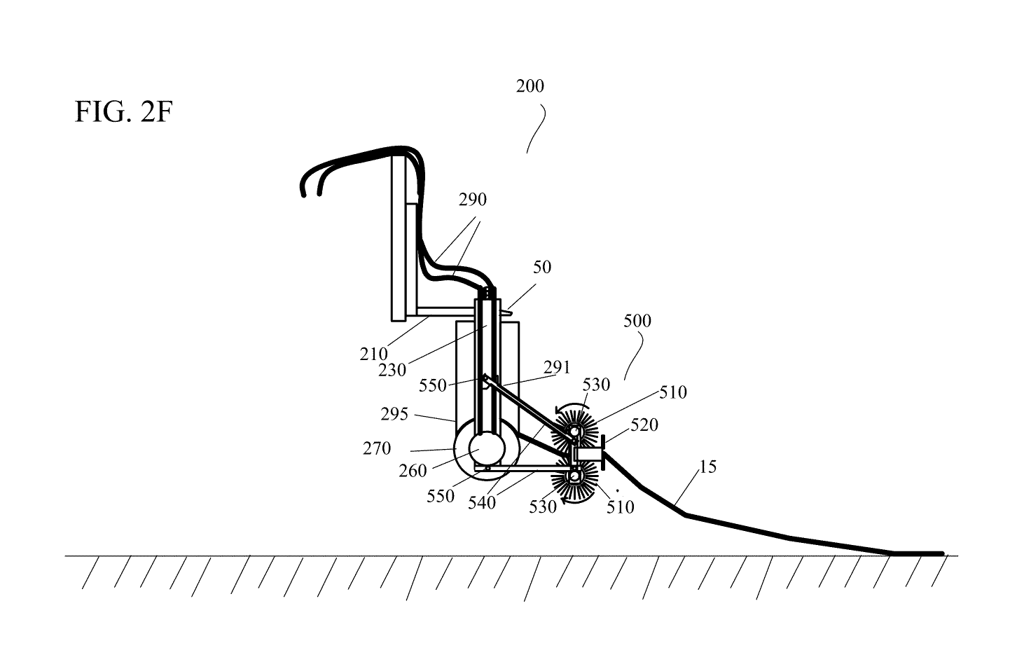

Referring now to FIG. 2A, we illustrate a preferred embodiment of a collection apparatus 200 used in conjunction with a generic self propelled carriage 12, in this preferred embodiment being a wheel loader fitted with a fork lift accessory 40. The hydraulic arms 50 of the wheel loader 12 provide for holding the collection apparatus 200 in its operational orientation, and also provide for lifting the completed roll and directly stacking it on a transport vehicle. The fork lift accessory 40 provides forks 50 upon which fork sleeves 210 on the collection apparatus 200 support bar 220 in turn can be secured. The fork sleeves 210 are secured to the forks 50 via bolts, or alternatively a turn-buckle running from the support bar 220 to the fork lift accessory 40.

The support bar 220 is hollow and accepts, at each end, yoke arms 230 which slide in and out of the support bar 220 via movement of linear actuators 240 mounted at one end to the support bar 220 and at the other end to the yoke arms 230. Movement of the linear actuators 240 thus increases or decrease the distance between the spindles 250 mounted on the lower end, and inner side, of the yoke arms 230. Motors 260 mounted on the lower end, and outer side of the yoke arms 230 provide motive power for the roller spindles 250. In other embodiments, a single linear actuator is used to move both yoke arms 230, or a single yoke arm 230 allowing the bobbin 253 to simply slide off the spindle 250 on the other yoke arm. In a preferred embodiment, two sliding yoke arms 230 are employed, and hydraulic pistons are used as linear actuators 240. Also in this preferred embodiment, the motors 260 are hydraulically driven. Hydraulic power for both the motors 260 and hydraulic piston linear actuators 240 is provided by hydraulic lines 290 which are in turn connected to the self propelled carriage 12 hydraulic system via industry standard quick-release hydraulic fittings provided on a wide variety of construction equipment for this purpose. In alternative embodiments, electrically driven linear actuators 240 and electric motors 260 are employed, and operatively connected to the electrical system of the self propelled carriage.

Accordingly, the collection apparatus 200 is combinable with numerous fork lift devices, or through alternative adaptive fixtures (clamps, brackets, etc), with bucket loaders, skid steers, agricultural tractors or other equipment capable of providing accessory hydraulic or electrical outputs and offsetting the weight of the roller and material it accumulates in the rolling process. In alternative embodiments, shown in FIG. 2C, a gasoline engine 182 or electric motor mounted on the collection apparatus 200 along with a hydraulic pump 184 provide hydraulic power to the linear actuators 240 and spindle 250 motors 260. In still further embodiments, shown in FIG. 2D, an electric generator 185 is mounted on the collection apparatus 200 and provides power to the linear actuators 240 and spindle 250 motors 260.

The collection apparatus spindles 250 are conical in shape and have at least one slit through their diameter to allow for contraction and expansion of the spindle 250 when pressure is applied inwardly by moving the spindles 250 closer together, or removed when the distance between the spindles 250 is increased.

Generally, prior to rolling operations, the yoke arms 230 are spread to their maximum distance through extension of the linear actuators 240. At this time a bobbin 252, which can be made of a length of PVC pipe, is preferably placed over one spindle 250, and the distance between the yoke arms 230 decreased until the bobbin 252 is held firmly in place via friction between its inner surface and the outer surface of the spindles 250. PVC pipe 252 is chosen for its low cost, general availability, and compatibility with later recycling of the geotextile rolls. However, metal tubes, or bars fitted in the slots 255 of the spindles 250 may also be used for this purpose.

Having placed the bobbin 252 in place, one end of a previously cut geotextile strip is affixed to it, either through tapes or glue, or using an attachment such as a slot 253 cut in the bobbin 252 or hooks, barbs, or clamps on the surface of the bobbin 252. The spindle 250 motors 260 are then activated causing the bobbin 252 to turn, rolling the geotextile strip 15 onto its outer circumference. The strength of the bobbin 252 is not a critical parameter, as the geotextile roll becomes self-supporting after only a few turns, and additional lateral pressure on the roll can be applied as necessary to keep the roll from slipping during rotation by moving the spindles 250 closer to the center of the roll using the linear actuators 240.

In some cases, the geotextile is of sufficiently heavy gauge, for example 60-80 mil (one mil=one thousandth of an inch), it is self supporting, so that the bobbin 252 may be omitted. Instead, the geotextile 15 is inserted into slots 255 in each spindle 250. The collection apparatus is shown in FIG. 2E without the bobbin 252, directly rolling a sheet of geotextile material 15.

Guide disks 270 at the thick end of the spindles 250 near the yoke arms 230 help ensure that the geotextile rolls in a uniform manner and does not wander to either side. Additional roll guides 295 are placed on the inside of the yoke arms 230 to further assist in this alignment procedure. These additional roll guides are either welded to the lower portion of the support bar 220, following the inner contour of the yoke arms 230, or hinged at the upper corner of the yoke arms 230. Chains 296 or cables also connecting the support bar 220 with the roll guides 295 maintain the location of the lower portion of the roll guides 295 near the rolled material when the yoke arms 230 are spread to release the final roll. In this manner, both spindles 250 can be removed from the finished roll without one or the other becoming stuck in the center of the completed roll.

A pre-cleaning apparatus 500, shown in FIG. 2F, having a scraper 520 and brushes 530 is optionally affixed to the collection apparatus 200 in front of the bobbin to clean the geotextile 15 as it is being rolled, in order to minimize foreign material that may be introduced into the recycling process of the geotextile rolls. The frame 540 of the pre-cleaning apparatus 500 is preferably attached to the yoke arms 230 using short studs and snap rings or clevis pins known in the agricultural implement industry for ease and rapidity of removal. The geotextile 15 material first passes through a slit scraper 520 that spans the entire width of the collection apparatus 200. Hence any large debris clinging to the geotextile 15 will be removed as it passes through the slit 520. The geotextile 15 then passes between two rotating brushes 510 that similarly span the entire width of the collection apparatus 200 yoke arms 230. These brushes are driven by hydraulic motors 530 fed by hydraulic lines 291 attached with standard quick release fittings (not shown) at the collection apparatus 200 yoke arms 230 so the pre-cleaning apparatus 500 may be easily removed from the collection apparatus 200 when unloading a roll of material.

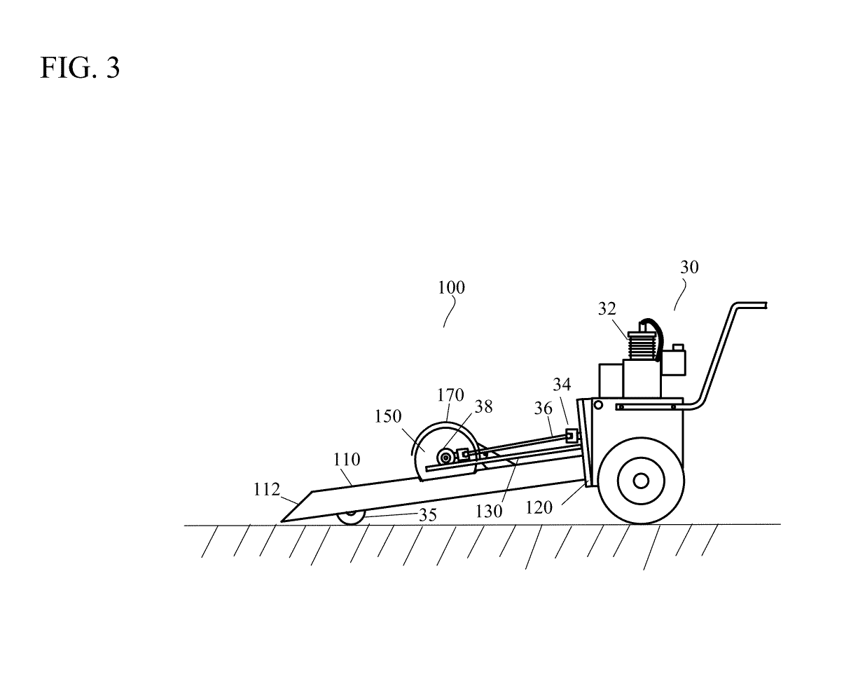

While FIGS. 1A-1B and FIGS. 2A-2F have illustrated large scale industrial applications of the cutting apparatus 100 and collection apparatus 200, these devices and their method of operation are completely scalable. FIG. 3 shows a cutting apparatus 100 mated to a self propelled carriage 30 having both drive wheels and a front power take off, as is commonly used in snow blowers, roto-tillers, and other small scale landscaping and home maintenance equipment. The mounting plate 120 has been appropriately sized and provided with mounting points for this purpose.

The self propelled carriage 30 is preferably powered by a gasoline engine 32, but is also capable of being powered by an electric motor. A universal joint 34 being powered by the self propelled carriage 30 mates with a drive shaft 36 that in turn provides power to a right angle transmission 38 to which the cutting disk 150 is attached. The lifting arm 110, service boom 130, and blade guard 170 are configured relative to each other and the mounting plate 120 as previously described. Additionally, a height adjustable wheel 35 is added under the lifting arm 110 to provide stability and to ensure that the bevel 112 of the lifting arm is optimally positioned to slide under the material to be lifted, but does not dig into potentially sensitive underlayment, such as fiberboard or plywood found under large area carpeting, or roofing membranes, for example.

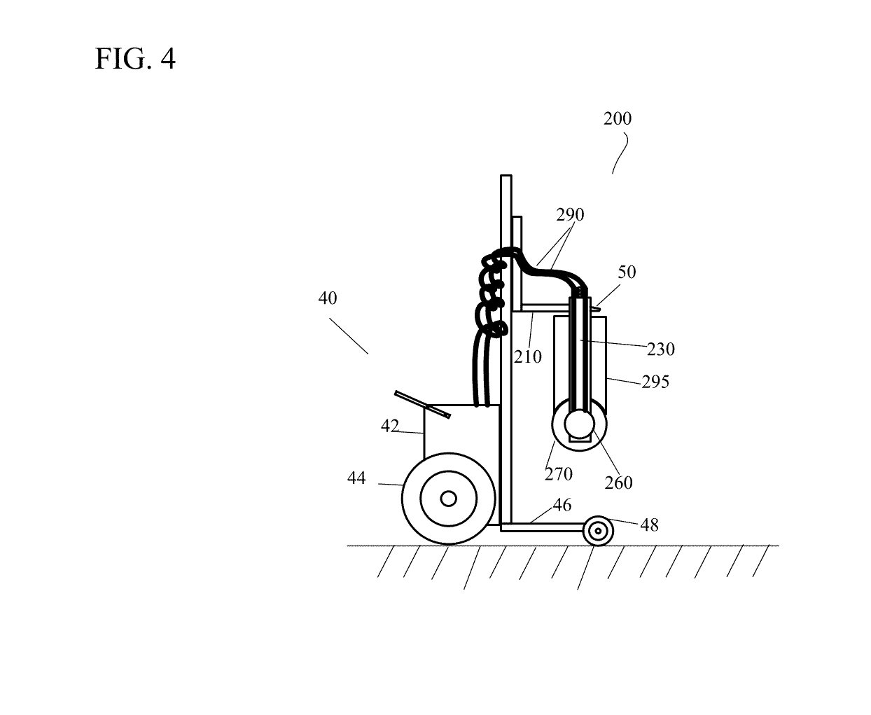

The collection apparatus 200 is similarly scalable for smaller operations as shown in FIG. 4. In this case, the collection apparatus 200 is scaled down but remains operationally substantially the same as previously described. In this embodiment the collection apparatus 200 has been combined with a walk-behind self-powered fork lift 40 as is commonly found in small scale warehouse operations, for example. The fork lift 40 has a drive unit 42 which may be battery powered, electrically powered, or provided with an internal combustion engine. Main drive wheels 44 provide for locomotion, while front guide wheels 48 on forward oriented outriggers 46 provide for stability. Depending on the type of fork lift employed, the collection apparatus motors 260 are hydraulically driven, or electrically driven, being coupled to the respective source at the fork lift drive unit 42 through appropriate cables or hoses 290.

Hence, these small scale embodiments are employable for removing man-made ground covering such as Astroturf® in indoor settings, large scale wall to wall carpeting in convention centers or other large spaces, roofing membranes used on residential and commercial structures, and any other large scale covering previously applied in areas that are not accessible to large scale machinery.

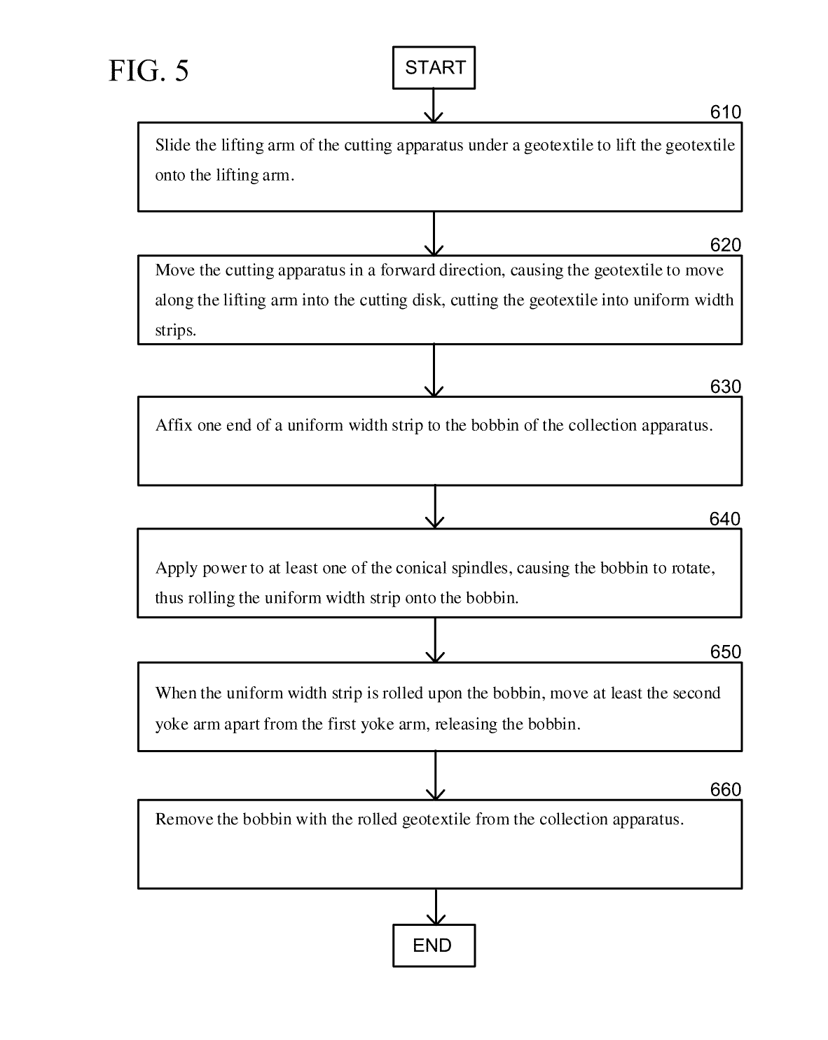

When used in combination, the cutting apparatus 100 and collection apparatus 200 provide an efficient, cost effective, and ecologically suitable means of recovering unwanted geotextiles. This method can be summarized as shown in FIG. 5 to include the following steps:
Step 610: slide the lifting arm 110 of the cutting apparatus 100 under a geotextile 15 to lift the geotextile 15 onto the lifting arm 110;
Step 620: move the cutting apparatus 100 in a forward direction, causing the geotextile 15 to move along the lifting arm 110 into the cutting disk 150, cutting the geotextile 15 into uniform width strips;
Step 630: affix one end of a uniform width strip to the bobbin 252 of the collection apparatus 200;
Step 640: apply power to at least one of the conical spindles 250, causing the bobbin 252 to rotate, thus rolling the uniform width strip onto the bobbin 252;
Step 650: when the uniform width strip is rolled upon the bobbin 252, move at least the second yoke arm 230 apart from the first yoke arm 230, releasing the bobbin 252; and
Step 660: remove the bobbin 252 with the rolled geotextile 15 from the collection apparatus 200.

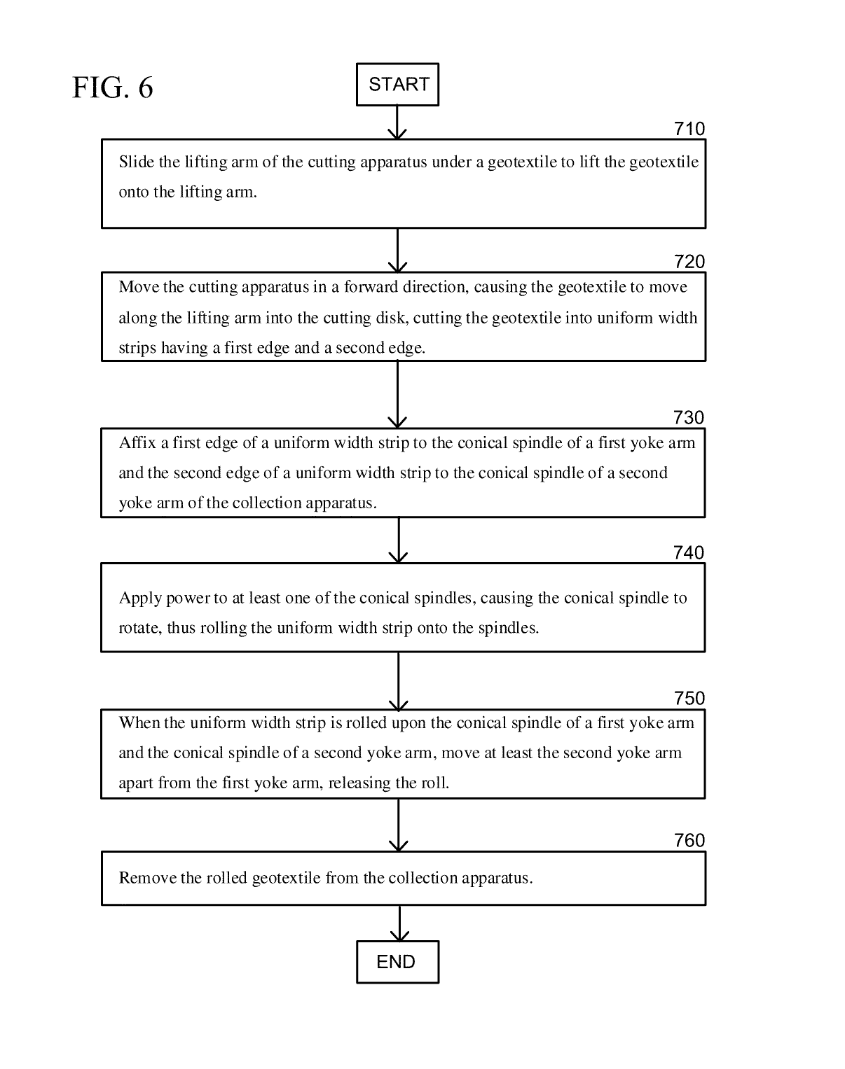

Alternatively, when heavy gauge, self supporting geotextiles are being collected and a bobbin 252 is omitted, this method can be summarized as shown in FIG. 6 to include the following steps:
Step 710: slide the lifting arm 110 of the cutting apparatus 100 under a geotextile 15 to lift the geotextile 15 onto the lifting arm 110;
Step 720: move the cutting apparatus 100 in a forward direction, causing the geotextile 15 to move along the lifting arm 110 into the cutting disk 150, cutting the geotextile 15 into uniform width strips having a first edge and a second edge;
Step 730: affix a first edge of a uniform width strip 15 to the conical spindle 250 of a first yoke arm 230 and the second edge of a uniform width strip 15 to the conical spindle 250 of a second yoke arm 230 of the collection apparatus 200;
Step 740: apply power to at least one of the conical spindles 250, causing the conical spindles 250 to rotate, thus rolling the uniform width strip 15 onto the spindles 250;
Step 750: when the uniform width strip 15 is rolled upon the conical spindle 250 of a first yoke arm 230 and the conical spindle of a second yoke arm 230, moving at least the second yoke arm 230 apart from the first yoke arm 230, releasing the roll; and
Step 760: remove the rolled geotextile 15 from the collection apparatus 200.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A geotextile cutting apparatus comprising:
a) a mounting plate having a front side, a back side;
b) a lifting arm having an apex on an upper surface, a first end fixed to the front side of the mounting plate, a second end having a bevel and a cutting disk slot between the first end and second end on the apex;
c) a service boom having a first end fixed to the front side of the mounting plate parallel to the lifting arm and a second end adjacent to the lifting arm cutting disk slot;
d) a motor mounted on the service boom having a power output; and
e) a cutting disk mounted on the service boom at least partly passing through the cutting disk slot, having a rotational axis rotationally coupled to the power output of the motor.

2. The geotextile cutting apparatus of claim 1 in which the motor is a hydraulic motor.

3. The geotextile cutting apparatus of claim 2, further comprising an internal combustion engine mounted upon the mounting plate and operatively connected to a hydraulic pump, the hydraulic pump being coupled to the hydraulic motor.

4. The geotextile cutting apparatus of claim 1 in which the motor is an electric motor.

5. The geotextile cutting apparatus of claim 4, further comprising an internal combustion engine mounted upon the mounting plate and operatively connected to an electric generator, the electric generator being coupled to the electric motor.

6. The geotextile cutting apparatus of claim 1, further comprising a cutting disk safety guard attached to the lifting arm covering at least part of the cutting disk.

7. The geotextile cutting apparatus of claim 1, in which the mounting plate is a skid-steer adaptor plate, and the back side of the mounting plate comprises an adaptor to fit the hydraulic arms of a skid-steer loader.

8. The geotextile cutting apparatus of claim 1, in which the cutting disk is mounted above the service boom, and at least part of the cutting disk extends downward through the cutting disk slot in the lifting arm.

9. The geotextile cutting apparatus of claim 1, further comprising at least one outrigger mounted to the mounting plate and extending outwardly therefrom, and a guide attached to an outer end of the outrigger.

10. The geotextile cutting apparatus of claim 9, in which the guide is a chain hanging downward from the outer end of the outrigger.

11. A geotextile collection apparatus comprising:
a) a support bar having a first end and a second end;
b) a first yoke arm having an upper end mounted to the first end of the support bar and a lower end rotatably supporting a conical spindle having a guide disk;
c) a second yoke arm having an upper end mounted to the second end of the support bar and a lower end rotatably supporting a conical spindle having a guide disk, the second yoke arm being movably mounted to the support bar such that a distance between the first yoke arm and the second yoke arm can be varied;
d) at least one linear actuator coupled to at least the second yoke arm for moving the second yoke arm relative to the first yoke arm, such that the distance between the first yoke arm and the second yoke arm is changed by actuating the linear actuator; and
e) at least one motor mounted on at least one of the first yoke arm or the second yoke arm, coupled to the conical spindle for rotation thereof;
such that a geotextile affixed to the at least one conical spindle having a guide disk is rotated by the at least one motor for collection of the geotextile in a roll, and the roll is removed by increasing the distance between the first yoke arm and the second yoke arm using the at least one linear actuator.

12. The geotextile collection apparatus of claim 11 in which the second yoke arm is movably mounted to the support bar by the upper end of the second yoke arm being slideably inserted into the second end of the support bar.

13. The geotextile collection apparatus of claim 11, in which the first yoke arm is movably mounted to the support bar and coupled to the at least one linear actuator.

14. The geotextile collection apparatus of claim 13 in which the first yoke arm is movably mounted to the support bar by the upper end of the first yoke arm being slideably inserted into the first end of the support bar.

15. The geotextile collection apparatus of claim 14, in which there are two linear actuators, the first yoke arm being coupled to a first linear actuator and the second yoke arm being coupled to a second linear actuator.

16. The geotextile collection apparatus of claim 11 wherein the at least one linear actuator is a hydraulic pistons.

17. The geotextile collection apparatus of claim 11 wherein the at least one linear actuator are electrically driven.

18. The geotextile collection apparatus of claim 11 in which the support bar further comprises a mount for coupling to a self-propelled carriage.

19. The geotextile collection apparatus of claim 18, in which the mount comprises a pair of pockets for coupling to forklift forks on the self-propelled carriage.

20. The geotextile collection apparatus of claim 11 wherein the at least one motor is hydraulic motors.

21. The geotextile collection apparatus of claim 11 wherein the at least one motor is electric.

22. The geotextile collection apparatus of claim 11, further comprising an internal combustion engine mounted to the support bar and operatively connected to an electric generator, the electric generator being coupled to the at least one linear actuator and the at least one motor.

23. The geotextile collection apparatus of claim 11, further comprising an internal combustion engine mounted to the support bar and operatively connected to a hydraulic pump, the hydraulic pump being coupled to the at least one linear actuator and the at least one motor.

24. The geotextile collection apparatus of claim 11 in which each of the first yoke arm and the second yoke arm further comprise a guide plate having a body with a cutout contoured to surround at least part of a circumference of the guide disk.

25. The geotextile collection apparatus of claim 24, wherein an upper end of the guide plates are attached to the first yoke arm and the second yoke arm by a hinge, and each of the guide plates is coupled to the support arm, such that when the distance between the first yoke arm and the second yoke arm is increased, a lower end of each guide plate is pulled inward toward a center of the bobbin.

26. The geotextile collection apparatus of claim 11, further comprising a pre-cleaning device attached to the first yoke arm and the second yoke arm, in front of the at least one conical spindle having a guide disk, for cleaning geotextile being rolled.

27. The geotextile collection apparatus of claim 26, in which the pre-cleaning device comprises an upper scraper spaced apart from a lower scraper, positioned such that geotextile being rolled onto the bobbin passes between the upper scraper and the lower scraper.

28. The geotextile collection apparatus of claim 26, in which the pre-cleaning device comprises an upper rotating brush spaced apart from a lower rotating brush, positioned such that geotextile being rolled onto the bobbin passes between the upper rotating brush and the lower rotating brush.

29. The geotextile collection apparatus of claim 11 further comprising a bobbin between the conical spindle having a guide disk of the first yoke arm and the conical spindle having a guide disk of the second yoke arm.

30. The geotextile collection apparatus of claim 29 in which the bobbin comprises an attachment for affixing a geotextile to the bobbin.

31. The geotextile collection apparatus of claim 30, in which the attachment is a slot in a surface of the bobbin.

32. A method of recovering a geotextile, using a cutting apparatus having a lifting arm having an apex on an upper surface with a forward end having a bevel and a cutting disk slot, and a motorized cutting disk at least partly passing through the cutting disk slot, and a collection apparatus comprising a support bar having a first end and a second end, a first yoke arm having an upper end mounted to the first end of the support bar and a lower end rotatably supporting a conical spindle having a guide disk, a second yoke arm having an upper end mounted to the second end of the support bar and a lower end rotatably supporting a conical spindle having a guide disk, the second yoke arm being movably mounted to the support bar such that a distance between the first yoke arm and the second yoke arm can be varied, and at least one motor for rotating at least one of the first conical spindle and the second conical spindle; the method comprising the steps of:
a) sliding the lifting arm of the cutting apparatus under a geotextile to lift the geotextile onto the lifting arm;
b) moving the cutting apparatus in a forward direction, causing the geotextile to move along the lifting arm into the cutting disk, cutting the geotextile into uniform width strips;
c) affixing an end of a uniform width strip to the collection apparatus;
d) applying power to motor, causing the at least one conical spindle to rotate, thus rolling the uniform width strip;
e) when the uniform width strip is rolled, moving at least the second yoke arm apart from the first yoke arm, releasing the rolled uniform width strip; and
f) removing the rolled geotextile from the collection apparatus.

33. The method of recovering a geotextile of claim 32, in which the collection apparatus further comprises a bobbin for rolling geotextile, removably mounted between the conical spindle of the first yoke arm and the conical spindle of the second yoke arm, and step (c) of the method comprises affixing an end of the uniform width strip to the bobbin.

34. The method of recovering a geotextile of claim 32, in which step (c) of the method comprises affixing an end of the uniform width strip to the conical spindle of the first yoke arm and the conical spindle of the second yoke arm.
